(19) United States
(12) Patent Application Publication
(10) Pub. No.: US 2026/0331090 A1
(43) Pub. Date: Oct. 22, 2026

(54) SOUND SIGNAL CONTROL METHOD, APPARATUS AND PROGRAM

(71) Applicant: NTT, Inc., Tokyo (JP)

(72) Inventors: Kenichi NOGUCHI, Tokyo (JP); Hiroaki ITO, Tokyo (JP); Hironobu CHIBA, Tokyo (JP); Tatsuya KAKO, Tokyo (JP)

(73) Assignee: NTT, Inc., Tokyo (JP)

(21) Appl. No.: 19/104,684

(22) PCT Filed: Aug. 26, 2022
(86) PCT No.: PCT/JP2022/032198

§ 371 Date: Feb. 18, 2025

(51) Int. Cl. G10K 11/178; G10K 15/02

(52) U.S. Cl. CPC G10K 11/17837; G10K 15/02; G10K 2210/503

(57) ABSTRACT

An audible signal control method according to one aspect of the present disclosure includes: a trait acquisition step of acquiring, by a trait acquisition unit, a trait of a user; and an audible signal control step of controlling, by an audible signal control unit, an input audible signal based on the acquired trait.

### TECHNICAL FIELD

The present disclosure relates to a technology for controlling audible signals.

### BACKGROUND ART

In order to provide a comfortable listening environment when using, for example, headphones, noise cancelation for suppressing external noise and capturing external sound from a microphone installed outside the headphones have been implemented (see, for example, Patent Literature 1).

### CITATION LIST

### Patent Literature

Patent Literature 1: JP 2009-021826 A.

### SUMMARY OF INVENTION

### Technical Problem

However, most of noise cancelation and external sound capturing schemes in the relate art provide the same effect for all users. Accordingly, appropriate effects may not be provided according to traits of a user.

For example, among users who want to create an environment in which they can concentrate using the noise cancelation, some are strongly affected by noise, and some are not affected by noise at all.

An object of the present disclosure is to provide an audible signal control method, a device, and a program capable of providing a user with a sound environment according to traits.

### Solution to Problem

According to one aspect of the present disclosure, an audible signal control method includes a trait acquisition step of acquiring a trait of a user; and an audible signal control step of controlling an input audible signal based on the acquired trait.

### Advantageous Effects of Invention

According to the present disclosure, it is possible to provide a sound environment to a user corresponding to their trait.

### BRIEF DESCRIPTION OF DRAWINGS

FIG. 1 is a diagram illustrating an example of a functional configuration of an audible signal control device.

FIG. 2 is a diagram illustrating an example of a processing procedure of an audible signal control method.

FIG. 3 is a diagram illustrating an example of processing executed by an audible signal control unit 2.

FIGS. 4A and 4B are diagrams illustrating an example of processing executed by the audible signal control unit 2.

FIG. 5 is a diagram illustrating a functional configuration example of a computer.

### DESCRIPTION OF EMBODIMENTS

Hereinafter, embodiments of the present disclosure will be described with reference to the drawings. In the drawings, components having the same functions are denoted by the same reference numerals, and redundant description will be omitted.

### Audible Signal Control Device and Method

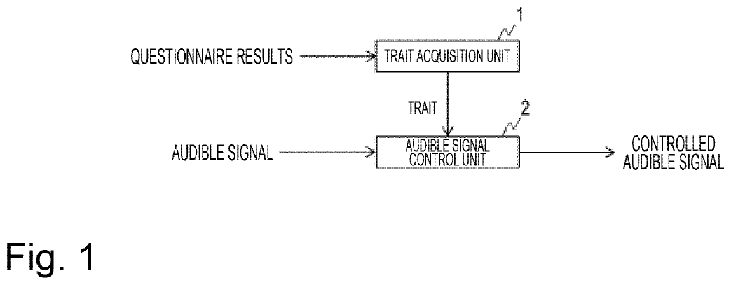

As illustrated in FIG. 1, the audible signal control device includes, for example, a trait acquisition unit 1 and an audible signal control unit 2.

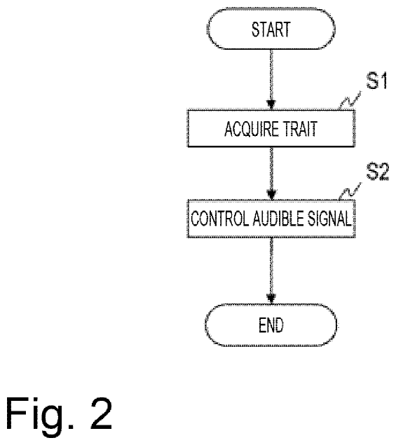

The audible signal control method is implemented, for example, by each component of the audible signal control device performing processing from step S1 and step S2 as illustrated in FIG. 2.

Each unit of the audible signal control device and processing of each step will be exemplified hereinbelow.

<trait Acquisition Unit 1>

The trait acquisition unit 1 acquires traits of a user (step S1).

The acquired trait of the user is output to the audible signal control unit 2.

For example, the trait acquisition unit 1 acquires the trait of the user based on the results of a questionnaire conducted in advance for the user. In this case, the results of the questionnaire conducted in advance for the user is input to the trait acquisition unit 1.

Examples of the questionnaire include Big 5 Personality Traits widely adopted in the field of psychology. However, the questionnaire is not limited to Big 5 or any other specific method as long as the user's trait can be identified.

The Big 5 Personality Traits is a factor analysis with five unique characteristics (openness to experience, conscientiousness, extroversion, agreeableness and neuroticism) to study personality (see Reference 1).

(Reference 1) Atsushi Oshio, Shingo Abe, Pino Cutrone (2012), “Nihongo ban Ten Item Personality Inventory (TIPI-J) sakusei no kokoromi (in Japanese) (Attempt to Create Japanese Ten Item Personality Inventory (TIPI-J))”, The Japanese Journal of Personality, 21, 40-52.

### <Audible Signal Control Unit 2>

An audible signal is input to the audible signal control unit 2. Furthermore, the user's trait acquired by the trait acquisition unit 1 is input to the audible signal control unit 2.

The audible signal control unit 2 controls an input audible signal on the basis of the acquired trait of the user (step S2). The controlled acoustic signal is output from the audible signal control unit 2 and presented to the user. Accordingly, it is possible to provide a sound environment corresponding to their trait to the user.

Hereinafter, two examples of sound control performed by the audible signal control unit 2 will be described.

Note that these are merely examples. The audible signal control unit 2 may control audible signals in a way other than these examples.

### Example 1

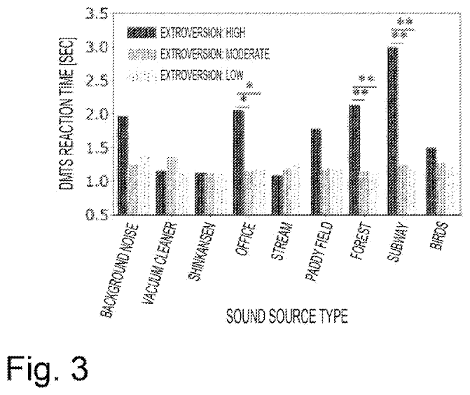

In general, in a case where the user is highly extrovert, the user is susceptible to external sound. In other words, a person who is highly extroverted tends to be more likely to be disturbed in concentration by the surrounding environmental sound. This can also be understood from the fact that the DMTS reaction time is longer (the degree of concentration is lower) for a person who is high in extroversion as illustrated in FIG. 3.

Therefore, since a user who tends to be highly extrovert is easily affected by the external sound, the audible signal control unit 2 performs control to increase a suppression amount in noise cancelation or reduce a captured amount of external sound. In other words, the audible signal control unit 2 performs control to reduce the noise suppression amount and increase the captured amount of external sound for a user who is lowly extrovert since such a user is hardly affected by external sound.

That is, the audible signal control unit 2 may control the audible signal such that (a) suppression amount in noise cancelation if the trait indicates that the user is highly extrovert is greater than the suppression amount in noise cancelation if otherwise, or alternatively, (b) the captured amount of external sound in noise cancelation if the trait indicates that the user is highly extrovert is smaller than a captured amount of external sound in noise cancelation if otherwise.

Note that, in a case where the user's extroversion indicated by the trait is larger than a predetermined first threshold value, the audible signal control unit 2 may control the audible signal so that the suppression amount in noise cancelation is larger than a predetermined first amount, or alternatively, the captured amount of external sound in noise cancelation is smaller than a predetermined second amount.

Further, in a case where the user's extroversion indicated by the trait is smaller than a predetermined second threshold value, the audible signal control unit 2 may control the audible signal so that the suppression amount in noise cancelation is smaller than a predetermined third amount, or alternatively, the captured amount of external sound in noise cancelation is larger than a predetermined fourth amount.

### Example 2

In a case where the trait indicates that the user is highly conscientious, the audible signal control unit 2 may perform control to generate and present a binaural beat.

In other words, the audible signal control unit 2 may control the audible signal so as to generate the binaural beat in a case where the user's conscientiousness indicated by the trait is higher than a predetermined third threshold.

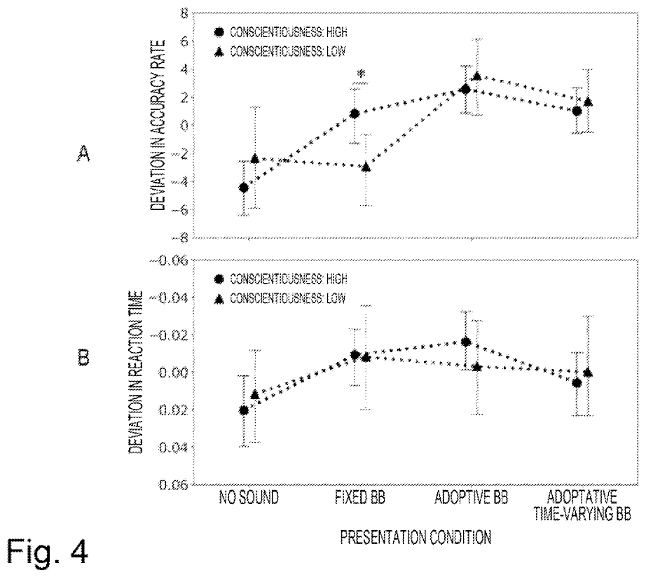

By means of the control shown in <<Example 2>>, as can be seen from FIG. 4A, a group of persons who are high in conscientiousness can be expected to increase efficiency by being exposed to binaural beat.

### Modified Examples

The specific configuration of the embodiment of the present disclosure is not limited to the configuration described above. The specific configuration of the embodiment of the present disclosure can be appropriately modified or altered in design without departing from the gist of the present disclosure.

The various types of processing described in the embodiments of the present disclosure may be performed not only in chronological order in accordance with the described order, but also in parallel or individually depending on the processing capability of a device that performs the processing or as necessary.

For example, data exchange between components of the audible signal control device may be performed directly or via a storage unit (not illustrated).

### [Program and Recording Medium]

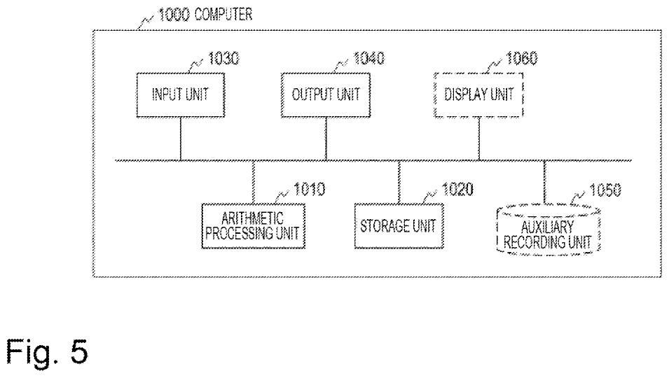

Processing of each unit of the audible signal control device described above may be implemented by a computer, and in this case, detailed processing of a function that each device needs to have is described by a program. Then, by causing a storage unit 1020 of a computer 1000 illustrated in FIG. 5 to read this program and causing, for example, an arithmetic processing unit 1010, an input unit 1030, an output unit 1040 and a display unit 1060 to operate, various processing functions in each device described above are achieved on the computer.

The program in which the processing contents are described can be recorded on a computer-readable recording medium. The computer-readable recording medium is, for example, a non-transitory recording medium and more specifically, includes a magnetic recording device or optical disc.

In addition, the program is distributed by, for example, selling, transferring, or renting a portable recording medium such as a DVD or CD-ROM in which the program is recorded. Further, the program may be stored in a storage device of a server computer and be distributed by transferring the program from the server computer to another computer via a network.

For example, the computer that executes the program first stores the program recorded in the portable recording medium or the program transferred from the server computer in an auxiliary recording unit 1050 serving as a non-transitory storage device of the computer. At the time of performing processing, the computer reads the program stored in the auxiliary recording unit 1050 serving as the non-transitory storage device of the computer into the storage unit 1020 and performs processing according to the read program. As another embodiment of the program, the computer may directly read the program from the portable recording medium into the storage unit 1020 and perform processing according to the program, or alternatively, each time the program is transferred from the server computer to the computer, the computer may sequentially perform processing according to the received program. In addition, the processing described above may be executed by a so-called application service provider (ASP) that implements a processing function only by an execution instruction and result acquisition without transferring the program from the server computer to the computer. Note that the program in the present embodiment includes information that is used for processing by an electronic computing machine and is equivalent to the program (for example, data that is not a direct command to the computer but has a property that defines processing of the computer).

Although the present device is configured by the predetermined program being executed on the computer in this embodiment, at least a part of the processing may be implemented by hardware. For example, at least one of the trait acquisition unit 1 and the audible signal control unit 2 may be configured by a processing circuit.

Moreover, modifications can be appropriately made without departing from the gist of the present invention.

All documents, patent applications, and technical standards described in this specification are incorporated herein by reference to the same extent as in a case where incorporation by reference of each document, patent application, and technical standard is specifically and individually described.

1. An audible signal control method, comprising:
a trait acquisition step of acquiring, by processing circuitry, a trait of a user; and
an audible signal control step of controlling, by processing circuitry, an input audible signal based on the acquired trait.

2. The audible signal control method according to claim 1, wherein in the trait acquisition step, traits of the user are acquired on the basis of the results of a questionnaire conducted with the user in advance.

3. The audible signal control method according to claim 1, wherein
in the audible signal control step, control is performed such that (a) a suppression amount in noise cancelation if the trait indicates that the user is highly extrovert is greater than a suppression amount in noise cancelation if otherwise, or alternatively, (b) a captured amount of external sound in noise cancelation if the trait indicates that the user is highly extrovert is smaller than a captured amount of external sound in noise cancelation if otherwise.

4. The audible signal control method according to claim 1, wherein
in the audible signal control step, control is performed to generate a binaural beat in a case where the trait indicates that the user is highly conscientious.

5. An audible signal control device, comprising processing circuitry configured to:
acquire a trait of a user; and
control an input audible signal based on the acquired trait.

6. A non-transitory computer readable medium that stores a program for causing a computer to execute processing of each step of the audible signal control method according to claim 1.
